(19) United States
(12) Patent Application Publication
(10) Pub. No.: US 2026/0146409 A1
(43) Pub. Date: May 28, 2026

(54) ACCESSORY MOUNTING SYSTEMS AND METHODS

(71) Applicant: Red Dog Vac Trac LLC, Austin, TX (US)

(72) Inventor: Oscar T. Scott, IV, Perryton, TX (US)

(73) Assignee: Red Dog Vac Trac LLC, Austin, TX (US)

(21) Appl. No.: 19/366,335

(22) Filed: Oct. 22, 2025

Related U.S. Application Data
(60) Provisional application No. 63/725,222, filed on Nov. 26, 2024.

(51) Int. Cl. E02F 9/08; B60R 9/02

(52) U.S. Cl. CPC E02F 9/0858; B60R 9/02

(57) ABSTRACT

An accessory mounting system is configured to be mounted on a vehicle component. The accessory mounting system includes a mounting bracket including at least a web and a flange at an angle to the web. The flange includes a notch having a recess sized to receive and retain at least a portion of a vehicle component therein under terrestrial gravitational force acting on the mounting bracket.

### BACKGROUND OF THE INVENTION

The present disclosure is generally directed to vehicle accessory mounting systems and associated methods.

The proliferation of vehicle accessories, recreational equipment, and other devices and equipment transported by vehicles has led to a growing demand for convenient and secure accessory mounting solutions for vehicles. While various accessory mounting systems exist, many suffer from limitations and disadvantages such as complicated or cumbersome installation, the requirement that the vehicle be permanently modified, the risk of damage to the vehicle, and/or instability or insecurity of the accessory or mounting system for the accessory. Further, existing accessory mounting systems often obstruct the driver's or passengers' view or interfere with vehicle operation.

### BRIEF SUMMARY

In view of the foregoing, the present disclosure appreciates many of the shortcomings in the prior art can be overcome by providing an improved vehicle accessory mounting system and method that offer stability, security, and ease of use. This innovative accessory mounting system easily integrates with a vehicle and provides a secure and unobtrusive platform for mounting a variety of accessory devices.

In one or more embodiments, the accessory mounting system supports tool-less installation.

In one or more embodiments, the accessory mounting system includes a mounting bracket. In one or more embodiments, the mounting bracket is integral to an accessory.

In one or more embodiments, the accessory mounting system includes a container, such as a toolbox, a basket, a liquid container, a wildlife feeder, a cooker (e.g., grill), etc.

In one or more embodiments, an accessory mounting system configured to be mounted on a vehicle component includes a mounting bracket including at least a web and a flange at a non-zero angle to the web. The flange includes a notch having a recess sized to receive and retain at least a portion of a vehicle component therein under terrestrial gravitational force acting on the mounting bracket.

In one or more embodiments, the accessory mounting system further includes an accessory coupled to the mounting bracket.

In one or more embodiments, the accessory mounting system is removably coupled to the mounting bracket via at least one mounting element. In one or more embodiments, the at least one mounting element includes at least one recess in the mounting bracket. In one or more embodiments, the at least one mounting element includes a hook.

In one or more embodiments, the accessory is integral with the mounting bracket.

In one or more embodiments in which the accessory includes a basket, the basket includes a sidewall having formed therein a selectively closeable opening.

In one or more embodiments, the mounting bracket includes a retention device configured to resist decoupling of the mounting bracket from the vehicle component. In one or more embodiments, the retention device includes a threaded bolt. In one or more embodiments, the retention device includes a wheel configured to engage the vehicle component.

In one or more embodiments, the flange is a first flange, the notch is a first notch, the recess is a first recess, and the portion is a first portion. The mounting bracket includes a second flange having formed therein a second notch including a second recess sized to receive and retain at least a second portion of the vehicle component therein. In one or more embodiments, the first and second flanges are substantially parallel. In one or more embodiments, the maximum dimension of the second notch along a long axis of the web is greater than a maximum dimension of the first notch along a long axis of the web.

### BRIEF DESCRIPTION OF THE SEVERAL VIEWS OF THE DRAWINGS

FIG. 1 illustrates an example of a vehicle to which an accessory mounting system can be coupled in accordance with one or more embodiments;

FIG. 2 is a more detailed view of a vehicle component in accordance with one or more embodiments;

FIG. 3 illustrates a plan view of an exemplary design for a mounting bracket of an accessory mounting system that may be coupled to a vehicle in accordance with one or more embodiments;

FIGS. 4A-4B depict perspective and elevation views of an exemplary mounting bracket of an accessory mounting system in accordance with one or more embodiments;

FIG. 5 is a perspective view of a mounting bracket of an exemplary accessory mounting system mounted on a vehicle in accordance with one or more embodiments;

FIG. 6 depicts an example of an accessory that may be detachably coupled to a mounting bracket of an accessory mounting system in accordance with one or more embodiments;

FIG. 7 illustrates an exemplary accessory mounting system mounted on a vehicle in accordance with one or more embodiments;

FIG. 8 illustrates a detailed view of a mounting bracket of an exemplary accessory system in which an accessory may be detachably coupled to the mounting bracket in accordance with one or more embodiments;

FIG. 9A depicts an exemplary accessory mounting system in which a mounting bracket is integral with an accessory in accordance with one or more embodiments;

FIG. 9B illustrates another exemplary accessory mounting system in which an accessory for a vehicle is separable from a mounting bracket in accordance with one or more embodiments;

FIG. 10 depicts a first exemplary embodiment of a retention device for a mounting bracket in accordance with one or more embodiments; and

FIGS. 11-12 illustrate a side elevation view and a partial section view of a second exemplary embodiment of a retention device for a mounting bracket in accordance with one or more embodiments.

### DETAILED DESCRIPTION

With reference to the figures and with particular reference to FIG. 1, there is illustrated an example of a vehicle 100 to which an accessory mounting system can be coupled in accordance with one or more embodiments. In this example, vehicle 100 is a tractor. In other embodiments, vehicle 100 can be, for example, construction equipment, a utility vehicle, automobile, truck, sports utility vehicle (SUV), side-by-side (SxS) vehicle, all-terrain vehicle (ATV), utility terrain vehicle (UTV), infantry squad vehicle (ISV) (or other military vehicle), or other vehicle. In the various embodiments, vehicle 100 includes a vehicle component 200.

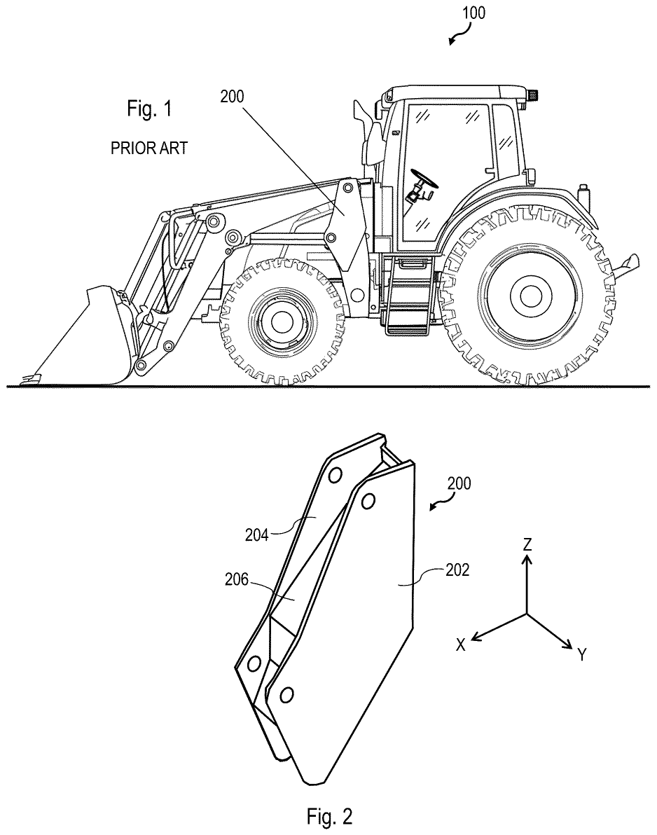

Referring now to FIG. 2, there is depicted a more detailed view of an

exemplary vehicle component 200 in accordance with one or more embodiments. In this example, vehicle component 200 can be, for example, a frame element or a support member. FIG. 2 illustrates vehicle component 200 in isolation for ease of understanding. The orientation of vehicle component 200 as installed in vehicle 100 is indicated by a three-dimensional Cartesian coordinate system having mutually orthogonal X, Y, and Z axes, with the Z (or vertical) axis indicating the direction opposite that of the force of terrestrial gravity.

In this example, vehicle component 200 includes a first plate 202, a second plate 204, and a connecting web 206. In some examples, vehicle component 200 can take the form of an I-beam, a C-channel, or, as shown, an irregular form. At edges at which first plate 202 and second plate 204 extend beyond web 206, flange(s) can be formed. It should be noted that, in this embodiment, vehicle component 200 has at least one region in which vehicle component 200 tapers (decreases) in dimension for increasing values of Z. Thus, vehicle component 200 can be said to have the form of an upward facing or inverted wedge. Vehicle component 200 can be formed, for example, of steel, aluminum, metal alloy, carbon fiber, plastic, or other metallic or non-metallic durable material.

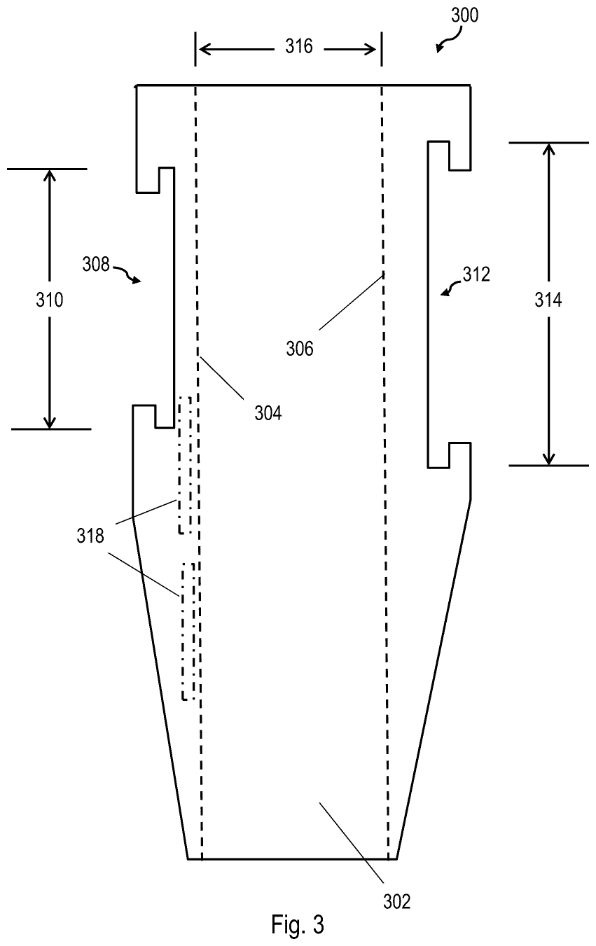

With reference now to FIG. 3, there is illustrated a plan view of an exemplary design for a mounting bracket blank 300 for an accessory mounting system that may be coupled to vehicle component 200 in accordance with one or more embodiments. In some examples, mounting bracket blank 300 may be formed from of a metal plate, expanded metal, welded wire, or other durable material. In some examples, mounting bracket blank 300 can be formed by cutting mounting bracket blank 300 out of sheet stock utilizing, for example, a waterjet cutter, laser cutter, plasma cutter, or mechanical cutter. In the example specifically shown in FIG. 3, mounting bracket blank 300 is formed of a planar sheet of metal, such as steel or aluminum. One or more edge(s) of mounting bracket blank 300 on the periphery of central region 302 can be bent (e.g., by a press brake) along bend lines 304 and 306 to form flanges. In some embodiments including two flanges at opposing edges of mounting bracket blank 300, the two flanges can be in two planes generally parallel to one another and orthogonal to a web of width 316 formed by central region 302, thus creating a flattened U-shaped member. Of course, in some examples including two flanges, the two flanges may not be parallel. Also, the flange(s) may not be perpendicular with respect to the web, but may instead be formed at a different non-zero angle Φ with respect to the web, where 0°<Φ<180°.

In a first flange, a first notch 308 is formed having a first maximum dimension

310 along a long axis of web 302. In a second flange, a second notch 312 is optionally formed having a second maximum dimension 314 along the long axis of web 302. In accordance with some preferred embodiments, dimension 310, which is sized to accommodate a dimension of vehicle component 200 along a first X-Y plane, is less than dimension 314, which is sized to accommodate a dimension of vehicle component 200 along a second X-Y plane spaced from the first X-Y plane along the Z axis a distance equal to width 316. As indicated by dashed line illustration, the first flange may have one or more holes (or recesses) 318 formed therein for receiving a mating element (e.g., a hook) coupled to a removable accessory (e.g., a toolbox, a basket, a liquid container, a cooker, a wildlife feeder, etc.).

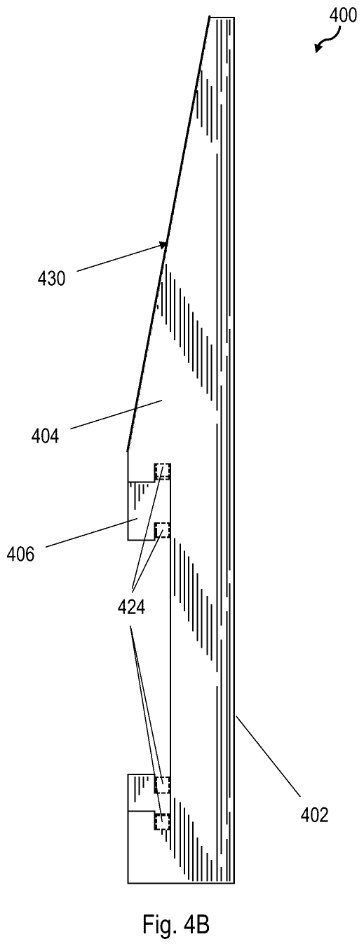

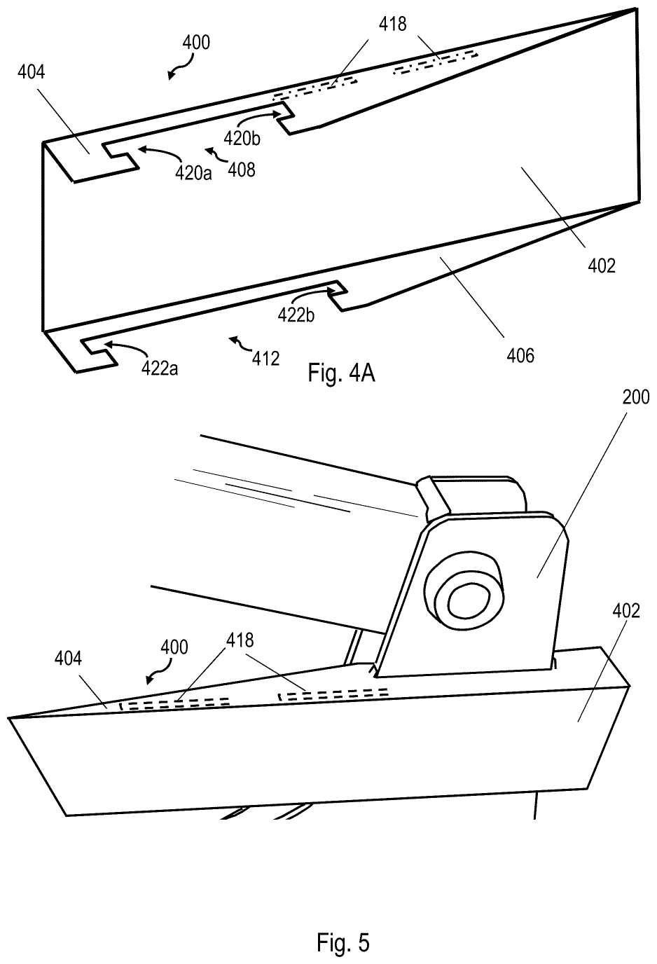

With reference now to FIGS. 4A-4B, there are illustrated perspective and

elevation views of an exemplary mounting bracket 400 of an accessory mounting system in accordance with one or more embodiments. In some embodiments, mounting bracket 400 can be formed from a mounting bracket blank 300 as discussed above. In other embodiments, mounting bracket 400 can have a different construction. For example, in some embodiments, flanges 404 and 406 may be formed of a bar or tube material (e.g., square or round steel or aluminum tube) rather than flat material. In some embodiments, web 402 may be formed of a welded wire, expanded metal, or a perforated material. Those skilled in the art will know how to dimension the members of mounting bracket 400 to achieve a desired rigidity, load capacity, and fit tolerance between notch 408 and/or optional notch 412 and vehicle component 200. As will be appreciated, one or more of flanges 404, 406 can be shaped to avoid interference with the operation of the vehicle or can be shaped to accommodate the shape of the attached accessory. For example, in the embodiment shown in FIGS. 4A-4B, edge 430 of flange 404 (and the corresponding hidden edge of flange 406) is tapered to prevent interference with the arms supporting the front-end loader of tractor 100.

In the illustrated example, mounting bracket 400 can include one or more

optional recess(es), such as mounting holes 418, or other mounting element(s) to enable an accessory to be removably coupled to mounting bracket 400. In some embodiments, web 402 may have one or more holes formed there through to support the attachment of a vehicle accessory and/or to secure mounting bracket 400 to a vehicle component. In some embodiments, notches 408, 412 include respective recesses 420a, 420b and 422a, 422b, which are sized to receive therein and engage flanges of a vehicle component, such as vehicle component 200. As specifically illustrated in FIG. 4B, in some embodiments, recesses 420, 422 are formed by cutting flaps 424 in flanges 404, 406 and then bending flaps 424 out of the planes of the respective flanges 404, 406. Flaps 424 can improve retention of mounting bracket 400 on a vehicle component by increasing frictional engagement between mounting bracket 400 and the vehicle component.

FIG. 5 is a perspective view of a mounting bracket 400 of an exemplary accessory mounting system mounted on a vehicle component 200 of a vehicle 100 in accordance with one or more embodiments. In the illustrated example, the installation of mounting bracket 400 on vehicle component 200 is tool-less. To install mounting bracket 400 on vehicle component 200, the flanges of vehicle component 200 are received within notches 408 and 412, and mounting bracket 400 is lowered along the Z axis until the peripheral flanges of vehicle component 200 frictionally engage the interior surfaces of recesses 420, 422 in notches 408 and 412. Mounting bracket 400 is removably retained on vehicle component 200 by a combination of that frictional engagement, the tapered shape of vehicle component 200, and the force of terrestrial gravity. Mounting bracket 400 can be toollessly removed from vehicle component 200 by reversing this process. For example, mounting bracket 400 can be removed from vehicle component 200 by lifting mounting bracket 400 along the Z axis until the interior surfaces of recesses 420, 422 in notches 408, 412 are disengaged from the peripheral flanges of vehicle component 200. In at least some embodiments, no bolts, screws, or other fasteners are utilized to secure mounting bracket 400 to vehicle component 200. As such, in such embodiments, the coupling of mounting bracket 400 to vehicle component 200 can be said to be without fasteners or “fastener-less.”

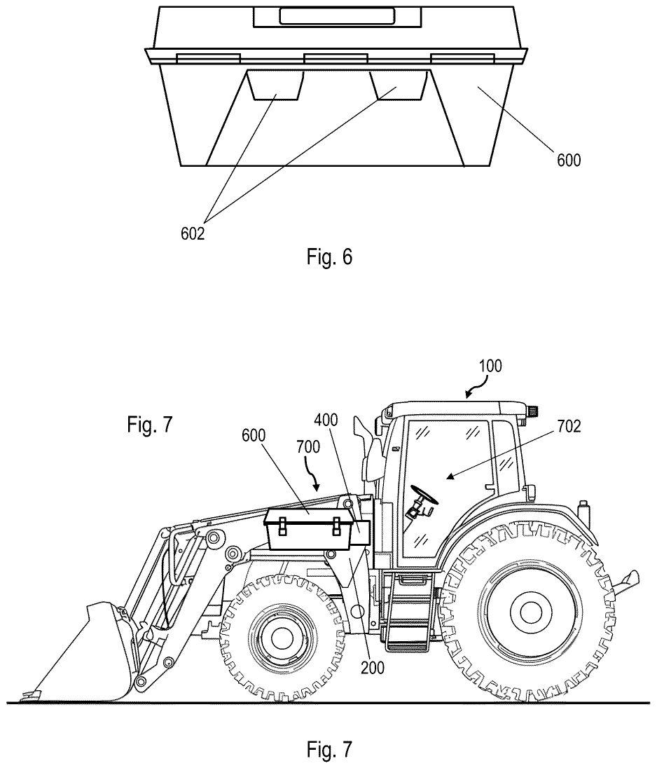

FIG. 6 depicts an example of an accessory 600 that may be removably coupled to a mounting bracket 400 of an accessory mounting system in accordance with one or more embodiments. In this example, accessory 600 comprises a toolbox. In other embodiments, accessory 600 can be an alternative accessory, such as a basket, liquid container, a cooker, a wildlife feeder, or other accessory. In this example, accessory 600 includes, has, or is coupled to one or more mounting element(s) 602, each of which can be, for example, a male mating element (as shown) or a female mating element. In this example, mounting elements 602, which take the form of hooks, can be received and retained within holes 418 formed in mounting bracket 400. In other examples, mounting elements 602 may cooperate with one or more hooks on an intermediate mounting plate in turn coupled to mounting bracket 400. The combination of mounting bracket 400 and accessory 600, optionally with one or more intermediate coupling elements, results in an exemplary accessory mounting system 700, as depicted in FIG. 7.

With reference now to FIG. 7, there is illustrated an exemplary accessory mounting system 700 in accordance with one or more embodiments. In this example, accessory mounting system 700 includes at least an accessory, such as accessory 600 of FIG. 6, and mounting bracket, such as mounting bracket 400 of FIG. 4. The mounting bracket in turn mounts on a vehicle component, such as vehicle component 200 of FIG. 2. Although not required, in this particular example, the accessory mounting system 700 is advantageously mounted on an exterior of vehicle 100 in a location proximate to a point of human ingress into and egress from vehicle 100, such as door 702. This mounting location enables a human user, such as an operator or passenger of vehicle 100, to conveniently access accessory 600 and/or its contents, for example, prior to entering or after exiting vehicle 100.

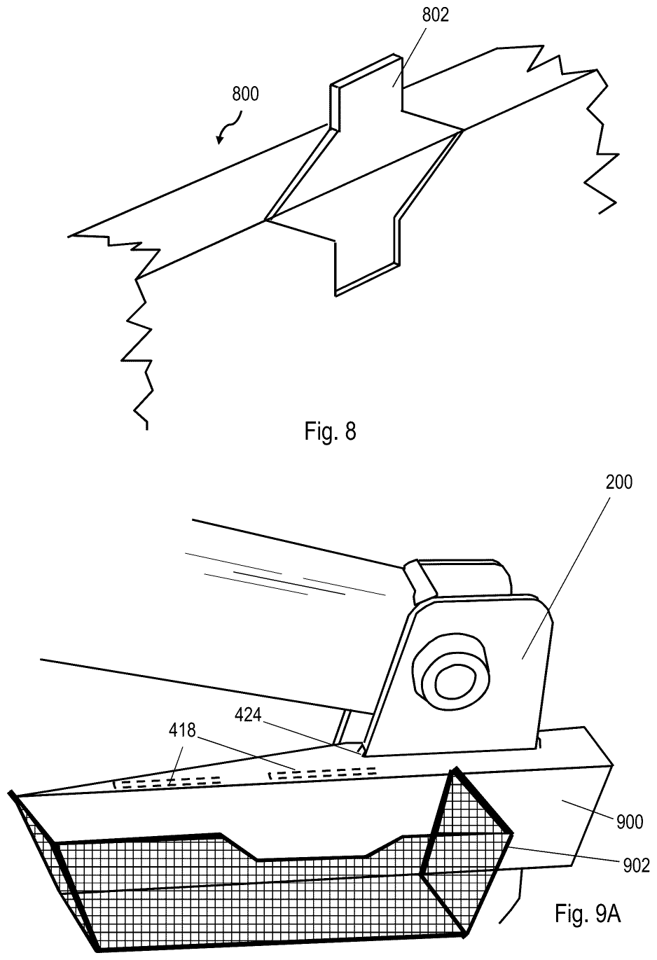

FIG. 8 illustrates a detailed view of a portion of an alternative embodiment of a mounting bracket 800 for an exemplary accessory system in which an accessory may be detachably coupled to the mounting bracket 800 in accordance with one or more embodiments. In particular, FIG. 8 shows that the mounting element integral to or coupled to mounting bracket 800 can be a male mating member 802. Male mating member 802, which can take the form of a protrusion or hook, can be removably received within a corresponding opening or recess in an accessory to couple the accessory to mounting bracket 800.

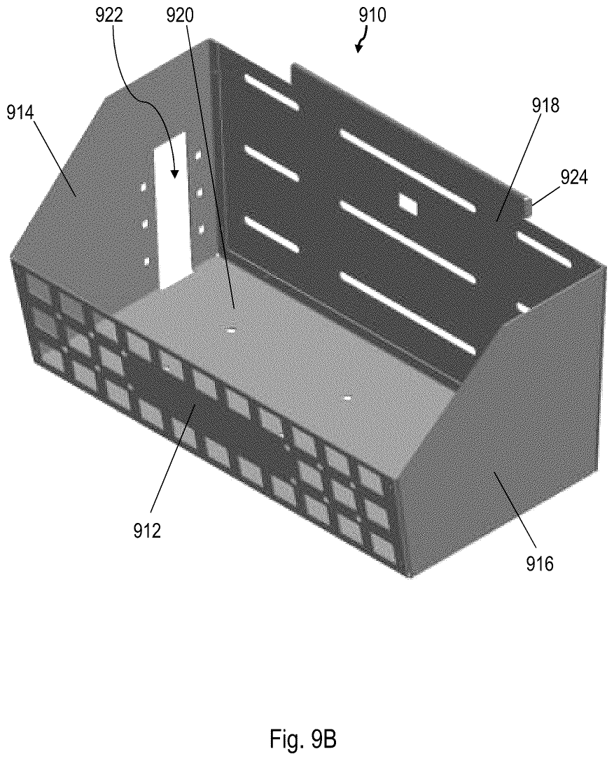

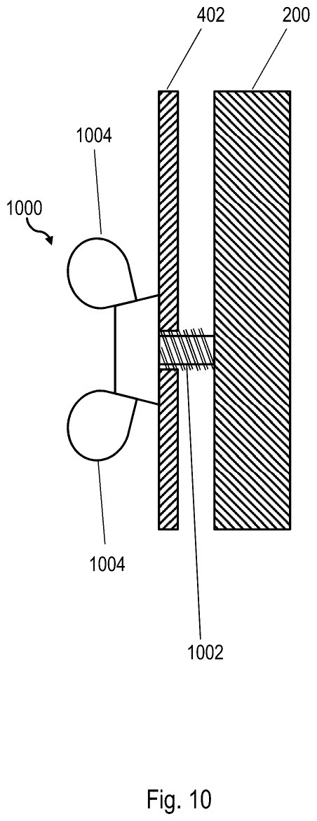

FIG. 9A depicts an embodiment of an exemplary accessory mounting system in which a mounting bracket 900 is integral with an accessory 902 in accordance with one or more embodiments. In this example, accessory 902 comprises a wire basket integral with mounting bracket 900. The accessory mounting system is not limited in the number of included accessories. Thus, in some embodiments, multiple accessories may be integral with or removably coupled to or contained within the mounting bracket and/or other accessories. As one specific example, a toolbox accessory may be dimensioned to be carried within the wire basket depicted in FIG. 9A.

Referring now to FIG. 9B, there is illustrated another exemplary embodiment of an accessory that can be mounted on a mounting bracket to form an accessory mounting system in accordance with one or more embodiments. In this example, the accessory comprises a basket 910 that is selectively coupleable to and separable from a mounting bracket, such as mounting bracket 400.

In this example, basket 910 includes a front wall 912, an opposing back wall 918, a first side wall 914, a second side wall 916, and a base 920. As shown, front wall 912 can be perforated with a number of regularly spaced openings to enhance visibility of contents of basket 910 and to support attachment of additional accessories, including clamps and/or brackets. In some embodiments, these openings can form a conventional Modular Lightweight Load-carrying Equipment (MOLLE) pattern. Front wall 912 can have a lesser height than back wall 918 as measured from base 920, for example, to facilitate insertion and removal of loads from basket 910. In some embodiments, one or more of side walls 914 and 916 can have at least one opening 922 formed therethrough, for example, to enable the extension of an article carried within basket 910 through the side wall(s). In some cases, an opening 922 can be selectively blocked and opened by an unillustrated moveable closure element or a deformable closure element, such as a rubber gasket. Base 920 can have one or more holes formed therethrough, for example, in order to permit drainage of liquids, such as water. Back wall 918 can include one or more openings therethrough, for example, to enable attachment of basket 910 to a mounting bracket 400 (or another vehicle component, vehicle accessory, or mounting point), for example, by screws or bolts. Back wall 918 may be coupled to or include an integral mounting element, such as a hook 924, which can be utilized to selectively couple basket 910 directly to a mounting bracket 400 or to another vehicle component, vehicle accessory, or mounting element.

In some embodiments or use cases, it may be desirable to augment the security of the coupling between the mounting bracket and vehicle component with a retention device. FIG. 10 depicts a section view of a first exemplary embodiment of a retention device 1000 for a mounting bracket 400 in accordance with one or more embodiments. In this example, retention device 1000 comprises a thumbscrew including a threaded bolt 1002 rigidly coupled to ears 1004 sized and configured to facilitate manual rotation of threaded bolt 1002. Threaded bolt 1002 is threadedly received in and cooperates with a threaded opening formed through web 402 of mounting bracket 400. In this embodiment, mounting bracket 400 can be retained in its installed position on vehicle component 200 by manually turning retention device 1000 clockwise until threaded bolt 1002 engages and tightens against vehicle component 200. The retention force applied by retention device 1000 can be removed by manually turning retention device 1000 counter-clockwise until threaded bolt 1002 no longer engages vehicle component 200.

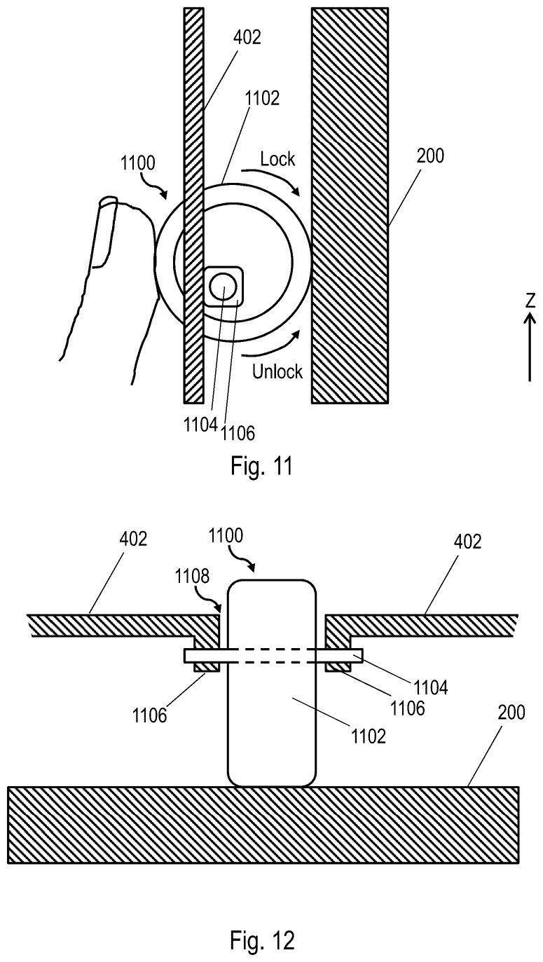

FIGS. 11-12 respectively illustrate a side elevation view and a partial section view of a second exemplary embodiment of a retention device 1100 for a mounting bracket 400 in accordance with one or more embodiments. In this example, retention device 1100 comprises a wheel 1102 disposed in a slot 1108 formed through web 402 of mounting bracket 400. Wheel 1102, which can incorporate an outer surface material (e.g., of rubber, foam, etc.) characterized by a high coefficient of friction, is mounted on and rotatable about an offset axle 1104 supported by ears 1106 integral to web 402. In this example, wheel 1102 is substantially circular, and offset axle 1104 is offset from a geometric center of wheel 1102. To promote retention of mounting bracket 400 on vehicle component 200, a user can manually rotate wheel 1102 in the indicated “lock” direction (i.e., clockwise in FIG. 11) to cause wheel 1102 to frictionally engage vehicle component 200. The retention force applied by retention device 1000 can be reduced or removed by manually turning wheel 1002 in the “unlock” direction (i.e., counter-clockwise in the view of FIG. 11) to reduce or eliminate frictional engagement of wheel 1002 with vehicle component 200.

As has been described, the present disclosure presents a mounting bracket, an accessory mounting system, and associated methods.

In the present description, the use of a singular term, such as, but not limited to, “a”, is not intended as limiting of the number of items. Further, the term “about” means the stated value plus or minus 10%. References to an “embodiment” or “embodiments” herein do not necessarily refer to the same embodiment(s), and features of various embodiments can be combined and/or substituted to form additional embodiments, as known to those skilled in the art. The term “coupled” includes any of or all of integral formation of elements, the direct attachment or connection of elements and/or the attachment or connection of elements via one or more intermediate elements.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

What is claimed is:

1. An accessory mounting system configured to be mounted on a vehicle component, the accessory mounting system comprising:
a mounting bracket including at least a web and a flange at a non-zero angle to the web, wherein the flange includes a notch having a recess sized to receive and retain at least a portion of a vehicle component therein under terrestrial gravitational force acting on the mounting bracket.

2. The accessory mounting system of claim 1, further including:
an accessory coupled to the mounting bracket.

3. The accessory mounting system of claim 2, wherein the accessory is removably coupled to the mounting bracket via at least one mounting element.

4. The accessory mounting system of claim 3, wherein the at least one mounting element includes at least one recess in the mounting bracket.

5. The accessory mounting system of claim 3, wherein the at least one mounting element includes a hook.

6. The accessory mounting system of claim 2, wherein the accessory is integral with the mounting bracket.

7. The accessory mounting system of claim 2, wherein the accessory includes a toolbox.

8. The accessory mounting system of claim 2, wherein the accessory includes a basket.

9. The accessory mounting system of claim 8, wherein the basket includes a sidewall having formed therein a selectively closeable opening.

10. The accessory mounting system of claim 1, wherein the mounting bracket includes a retention device configured to resist decoupling of the mounting bracket from the vehicle component.

11. The accessory mounting system of claim 10, wherein the retention device includes a threaded bolt.

12. The accessory mounting system of claim 10, wherein the retention device includes a wheel configured to engage the vehicle component.

13. The accessory mounting system of claim 1, wherein:
the flange is a first flange, the notch is a first notch, the recess is a first recess, and the portion is a first portion;
the mounting bracket includes a second flange having formed therein a second notch including a second recess sized to receive and retain at least a second portion of the vehicle component therein.

14. The accessory mounting system of claim 13, wherein the first and second flanges are substantially parallel.

15. The accessory mounting system of claim 13, wherein the maximum dimension of the second notch along a long axis of the web is greater than a maximum dimension of the first notch along a long axis of the web.

16. A method of mounting an accessory mounting system on a vehicle, the method comprising:
providing a mounting bracket including at least a web and a flange at an angle to the web, wherein the flange includes a notch having a recess sized to receive and retain at least a portion of a vehicle component therein under terrestrial gravitational force acting on the mounting bracket;
mounting the mounting bracket on the vehicle component such that the portion of the vehicle component is received in the recess of the notch; and
coupling a vehicle accessory to the mounting bracket.

17. The method of claim 16, wherein the coupling includes coupling the vehicle accessory by a hook coupled to at least one of the mounting bracket and the vehicle accessory.

18. The method of claim 16, further comprising:
engaging a retention device on the mounting bracket in contact with the vehicle component, such that decoupling of the mounting bracket from the vehicle component is resisted.
